(19) United States
(12) Patent Application Publication
(10) Pub. No.: US 2026/0220423 A1
(43) Pub. Date: Jul. 30, 2026

(54) MACHINE LEARNING MODEL EXPLANATION GENERATION

(71) Applicant: BlackBerry Limited, Waterloo (CA)

(72) Inventor: Bamidele Ajayi, Toronto (CA)

(21) Appl. No.: 19/041,333

(22) Filed: Jan. 30, 2025

(51) Int. Cl. G06N 3/043; G06N 3/0455

(52) U.S. Cl. CPC G06N 3/043; G06N 3/0455

(57) ABSTRACT

In some examples, a system obtains an approximation function for a machine learning (ML) model, the approximation function providing an approximate representation of a latent representation of latent features in a latent space produced by the ML model. The system presents a visualization of the latent features using the approximation function, and the system generates a refined latent space based on user input in the visualization. The system generates an explanation regarding which latent features of the latent space are primary contributors to a decision of the ML model.

### BACKGROUND

A machine learning (ML) model can make predictions or classifications based on input data. The ML model can be trained to make the predictions or classifications using labeled or unlabeled data. An ML model can be trained using supervised learning, in which a labeled data set is provided to update the machine learning model. Alternatively, an ML model can be trained using unsupervised learning, in which the ML model updates itself based on discovering patterns or data clusters in an unlabeled data set.

### BRIEF DESCRIPTION OF THE DRAWINGS

Some implementations of the present disclosure are described with respect to the following figures.

FIG. 1 is a block diagram of a system including a variational autoencoder (VAE) and a machine learning (ML) explanation generation engine, according to some examples of the present disclosure.

FIG. 2 is a flow diagram of a process according to some examples of the present disclosure.

FIG. 3 is a flow diagram of an explanation generation process according to some examples.

FIG. 4 is a flow diagram of a VAE enhancement process according to some examples.

FIG. 5 is a flow diagram of a latent space exploration process according to some examples.

FIG. 6 is a flow diagram of an ML model explanation interactive feedback process according to some examples.

FIG. 7 is a flow diagram of an optimization process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Different types of machine learning (ML) models can be used, including an autoencoder, which is a type of deep learning model. An autoencoder can be trained to discover latent variables of input data. The latent variables are variables of input data that are not directly observable (i.e., the variables are hidden). However, the latent variables may influence how observable variables of input data are distributed. The latent variables of an input data set form a latent space of the input data set. During training, the autoencoder learns which latent variables can be used to most accurately reconstruct the original data. In the ensuing discussion, latent variables are also referred to as “latent features.”

An autoencoder models the latent space through dimensionality reduction, by compressing data into a lower-dimensional space (the latent space) that captures the meaningful information contained in the input data. Note that some data in the input data contains background noise. The compression performed by the autoencoder produces the most relevant information, i.e., the latent features.

A variational autoencoder (VAE) is a specific type of autoencoder. Similar to other types of autoencoders, a VAE is able to discover latent features in input data. However, instead of encoding a discrete representation of latent features, the VAE has an encoder to encode a continuous, probabilistic representation of the latent features in the latent space. The encoder of a VAE is able to generate a probability distribution for each latent feature in the latent space based on input data. The VAE further includes a decoder to reconstruct the input data based on the probabilistic representation of the latent features provided by the encoder.

A VAE can capture complex relationships and structures within input data, and the VAE can use those insights to create new information. For example, VAEs can be used to perform image generation, image processing, language processing, and anomaly detection in computing systems.

However, a challenge faced by developers or users of a VAE is determining which subset of latent features of a latent space contributed more to a decision (output) provided by the VAE (as compared to other latent features of the latent space. The latent space may include a large quantity of latent features, so that it can be difficult to identify which of the latent features provided more significant contributions to the VAE's decision. The identification of the subset of latent features contributing to the decision of the VAE is part of generating an explanation relating to the operation of the VAE. The generated explanation can assist developers and users in understanding how the VAE made its decisions. This can assist the developers and users in tuning the VAE to improve the functionality of the VAE.

Using techniques or mechanisms according to some examples of the present disclosure, improvements in computer functionality and the relevant technology of machine learning can be achieved by identifying latent features that contribute most to decision making processes of ML models such as autoencoders (including VAEs).

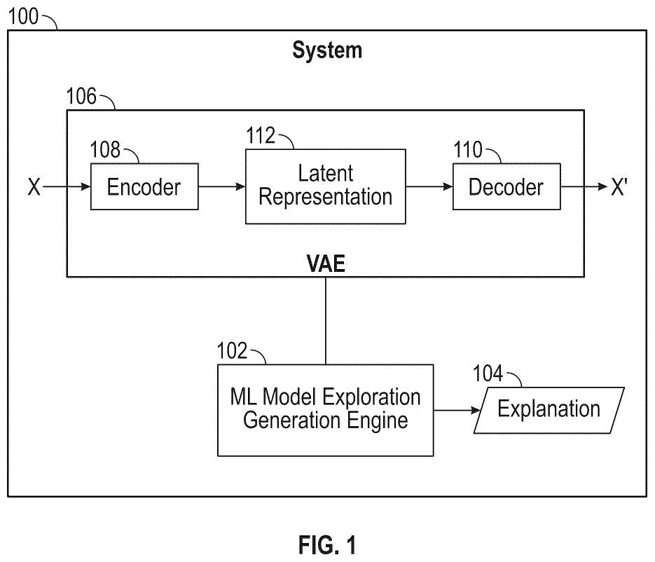

FIG. 1 is a block diagram of a system 100 including an ML model explanation generation engine 102 that is able to generate an explanation 104 for an ML model, which in some examples can be a VAE 106. Although reference is made to the VAE 106 according to some examples, the ML model explanation generation engine 102 can be used to generate explanations for other types of ML models.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

The VAE 106 includes an encoder 108 and a decoder 110. The encoder 108 receives input data X (in a data domain) and generates a latent representation 112 including probability distributions for respective latent features in the latent space based on input data X. The decoder 110 reconstructs the input data and outputs reconstructed data X′ (in the data domain) based on the latent representation 112 provided by the encoder 108. The encoder 108 does not output a single deterministic point in the latent space from the input data X. Instead, for a given input data X, the encoder 108 outputs parameters of a probability distribution, such as an N-Gaussian distribution probability or multivariate normal distribution probability. For example, the parameters can be the mean vector and a covariance matrix (or just a diagonal covariance matrix) of a multivariate normal distribution (of a N-dimensional vector) in the latent space. During the training of the VAE 106, a sampling process (i.e., a point from the distribution probability (in the latent space) associated with the input data X is obtained to be used by the decoder 110) is performed using the reparameterization trick, which ensures that the sampling process is differentiable and allows the VAE 106 to be trained using gradient-based optimization. During the training of the VAE 106, the reconstruction loss enables the decoder 110 to produce outputs that are similar to the original input data X, regardless of the small stochastic variations in the latent representation 112.

In one implementation of the disclosure, the VAE 106 is used to detect a malware file, when the input data is a file, which is either a binary file or a source code file (in assembly language for example).

If the input data X represents a data encryption malware file (such as ransomware, crypto jacking), the encoder 108 might learn to map these files to a Gaussian distribution centered around a specific region of the latent space. If the input data X represents a network-based malware file (such as packet sniffers, botnets), the encoder 108 might learn to map these files to a Gaussian distribution centered around a different region of the latent space representation.

In a variant, the input data X corresponds to a vector comprising features extracted from an executable file or a script or a network traffic log. The features can be related to API call patterns, byte n-grams, opcode sequences, etc. The VAE 106 can be used to detect anomalies (i.e., when the reconstructed data X′ is different from the input data X according to a distance comparison and a threshold value).

In another embodiment, the input data X corresponds to an image. The image can be for example a greyscale image obtained from a conversion process applied on a binary file. The VAE 106 can be used to detect malwares by processing images associated with binary files.

In one implementation, the ML model explanation generation engine 102 can be used to generate explanations on the contribution of features in the latent representation 112 on the reconstructed data X′, when the VAE 106 has been trained. Indeed, the ML model explanation generation engine 102, by using visualization techniques combined with dimensional reduction techniques like PCA (Principal Component Analysis), UMAP (Uniform manifold approximation and projection), t-SNE (t-distributed stochastic neighbor embedding), TriMap or PaCMAP (Pairwise Controlled Manifold Approximation), enables the exploration of the latent space of the VAE. Following that it is possible to apply a clustering algorithm (e.g., K-means, hierarchical clustering, DBSCAN) to the projected vectors (i.e., that are vectors from the latent representation that have been projected on a lower dimensional space). Identifying clusters from projected vectors of the latent space can provide insights into the structure and characteristics of the latent space itself. In one embodiment, the dimensional reduction techniques are applied on latent vectors (also named as points in the latent space) that are sampled from the probability distributions defined by the parameters outputted by the encoder. Indeed, these latent vectors correspond to specific points in the latent space. In one implementation, the ML model explanation generation engine 102 can be used to perform a linear interpolation between two points in the latent space, and use the decoder 110 to obtain the reconstructed data associated with the intermediate points. The ML model explanation generation engine 102 enables the determination of the contribution of some dimensional values in the latent space in the reconstructed data. In another implementation, the ML model explanation generation engine 102 can be used to modify one latent variable/dimension of a vector from the latent space representation, while keeping others fixed, and the ML model explanation generation engine 102 obtains with the decoder the reconstructed data X′. The analysis of the reconstructed data X′ enables the identification of a role of a specific latent variable/dimension in the latent space representation on features in the domain of the reconstructed data X′. For example, if the reconstructed data X are images, the features in the domain could be related to shape, rotation, etc. In a variant, visualization techniques can also be applied directly to the means predicted by the encoder (to understand the expected location of data in the latent space).

In another implementation, instead of a VAE, a GAN (Generative Adversarial Network) architecture is used. The GAN includes a generator network that maps a vector from a latent space to a point/element in a data space, and a discriminator network that evaluates whether a given element from the data space is generated or not by the generator network. In this context, the ML model explanation generation engine 102 can be used to investigate the latent space of the generator network.

In another implementation, instead of a VAE, a transformer architecture with an encoder and a decoder can be used. In this context, the purpose of the decoder is not to reconstruct the data provided as input to the encoder. However, the output of the encoder can be viewed as a latent space. Hence, the ML model explanation generation engine 102 can be used to determine the impact of modifications in the latent space on the final result. For example, the ML model explanation generation engine 102 can enable the detection of the components within the latent space that impact the classification of a binary file as a malware. Indeed, the encoder part of the transformer architecture can be used to process from the input data X (such as a binary file) some features (e.g., byte sequences, API calls comprised in the input data X) and it outputs a vector in a latent space that captures the important features of the input data X. Then, the decoder part of the transformer architecture is used for classification purpose. The ML model explanation generation engine 102 enables the determination of the contribution of a component of a vector in the latent space to the classification.

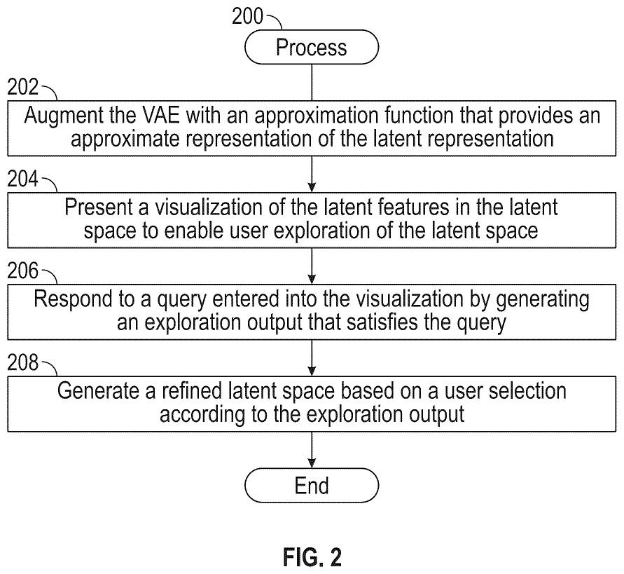

FIG. 2 is a flow diagram of a process 200 performed by the ML model explanation generation engine 102, in accordance with some examples of the present disclosure. The ML model explanation generation engine 102 enhances a representational power of the VAE 106 to capture latent features for the explanation 104. The enhancement is provided by augmenting (at 202) the VAE 106 with an approximation function that provides an approximate representation of the latent representation 112. Augmenting the VAE 106 (or more generally, an ML model) with the approximation function refers to obtaining or producing the approximation function for the VAE 106 (or more generally, the ML model).

The approximation function can be a mathematical relationship or model that can generate outputs close to the set of vectors used in the training of the VAE. For example, for a set of m sampled vectors

$$( {\{ {x}_{i} \}}_{i = 1}^{m} ,$$

with m being an integer greater than one) in the latent space (being an N-dimensional space), the approximation function f is a function such that f(xᵢ)~xᵢ or f(xᵢ) captures most of the information of xᵢ (such as a projected value of xᵢ). Such approximation function f can be used to infer values for new vectors that were not in the dataset. It can also be used to detect topological features in the latent space such as clusters. The enhancement aims to ensure that the latent representation 112 captured by the VAE 106 is rich enough to convey meaningful insights about the decision-making process of the VAE 106.

In some examples, the approximation function is a Kolmogorov Arnold Network (KAN) that can focus on latent features of the input data X. The latent representation 112 is a multivariate latent function that includes probability distributions for respective latent features in the latent space. The KAN is an example of an advanced neural network, and the KAN component can represent a continuous multivariable function (e.g., the multivariate latent function) as a superposition of a finite number of univariate functions. The multivariate latent function represents multiple variables, including the latent features of the latent space. Each variable is represented by a probability distribution.

The KAN learns and approximates the complex multivariate latent function by breaking it down into simpler functions (univariate functions) to approximate the multivariate latent function to a target level of accuracy. A univariate function is a function formed with a single variable. The KAN leverages the decomposition of a high dimensional problem (including multiple latent features) into multiple one-dimensional sub-problems. The KAN also provides the structure for a more interpretable framework for understanding how inputs are converted into outputs because the KAN employs explicit compositions of simpler one-dimensional functions.

In other examples, other types advanced neural networks for approximating the multivariate latent function can be used to augment the VAE 106. In yet further examples, the VAE 106 can be augmented with an attention mechanism. An attention mechanism is a machine learning mechanism that determines the relative importance of each component in a collection of components relative to the other components in the collection. In this case, the collection of components includes the latent features of the latent space in the latent representation 112. In another implementation, a neural network is trained on sampled vectors from the latent space of the VAE to classify the corresponding data input X into predefined categories. In a variant, a neural network is trained on sampled vectors from the latent space of the VAE to learn a transformation that predicts how a latent vector should change to achieve a target attribute in the reconstructed data output by the decoder of the VAE.

The ML model explanation generation engine 102 can present (at 204) a visualization (a two-dimensional (2D) or three-dimensional (3D) visualization) of the latent features in the latent space to enable user exploration of the latent space. The visualization is a 2D or 3D graph that can be displayed in a display device of an electronic device of the user.

In one implementation, the visualization presented by the explanation generation engine 102 is based on projecting the output of the approximation function (e.g., a KAN) onto a low dimensional space to enable graphical representation. For example, the output of the KAN is projected into the visualization by plotting univariate functions of the KAN as contour plots or line plots or other graphical elements.

The visualization allows the user to interactively navigate and explore the latent space in a manner that reveals the rationale behind predictions made by the VAE 106. The user can input queries into the visualization, where the queries can include constraints. For example, the visualization can include a graphical user interface (GUI) with input fields for the user to enter the input queries. The ML model explanation generation engine 102 can respond to a query entered into the visualization by generating (at 206) an exploration output that satisfies the query. The exploration output generated by the ML model explanation generation engine 102 provides feedback to the user.

In an example, a query that is input into the visualization can be based on the user selecting N (N≥1) latent features presented in the visualization. Based on the selected N latent features, the ML model explanation generation engine 102 can generate the exploration output by adding indicators highlighting the contribution of each of the selected N latent features to a decision made by the VAE 106. The indicators can show how the selected latent features affect the reconstructed data X′ by using techniques such as gradient based analysis and feature ablation reveal analysis. For the gradient-based analysis, the gradients of the reconstruction loss (∥X-X′∥) are calculated with respect to each of the chosen latent features (Z1, Z5, Z8). This informs the magnitude and direction of change these features bring to the reconstruction. For instance, Z1 may impact greatly on the shape of a particular malware signature, while Z5 may impact its entropy-based attributes. For the feature abatement reveal analysis, the ML model explanation generation engine 102 gradually turns off (ablates) the chosen features one at a time (for instance, setting Z5=0) to see how this affects the reconstructed malware sample. This enables one to see which parts of the reconstruction (e.g. header information, opcode patterns, etc.) are most sensitive to the chosen latent features. The output is shown as a set of indicators superimposed on the visualization. For instance, an output can be as follows: Z1 alters the signature shape by 40%; Z5 affects entropy distribution by 35%; and Z8 changes the opcode sequence by 25%. This output helps the user to understand the role of the chosen latent features in the decision making of the VAE 106 and hence gain understanding of the factors that are most influential in the reconstruction process.

As another example, the query that can be input by the user can include a constraint, such as a filter. For example, a constraint can seek items with specific characteristics (e.g., generate images of cats with black fur and green eyes). This constraint filters the latent space to include only features representing black fur and green eyes, and the model reconstructs images satisfying this constraint. As another example, the constraint can seek files belonging to specific users of an organization, or that were updated during specific dates and times.

In response to the query, the reconstructed data X′ from the decoder 110 of the VAE 106 can be modified such that data points or latent features satisfy the constraint of the query. The input data X is processed or filtered based on the constraint. The input data X is passed through the VAE 106 to generate a prediction for the specific query constraint. For example, when a user provides a query with a constraint, such as filtering based on specific attributes (e.g., “generate images of cats with black fur and green eyes”), the reconstructed data X′ from the VAE's decoder 110 is adjusted. This ensures the output data points or latent features satisfy the query's constraint.

Alternatively, the latent space generated by the encoder 108 can be manipulated to satisfy the constraint, and the output (reconstructed data X′) of the VAE 106 is generated by decoding from the adjusted latent features in a reconstruction scenario. Manipulating the latent space based on the constraint includes adjusting values assigned to the latent features in the latent space. For example, the latent features are adjusted by filtering, traversing, or manipulating the latent space to match the query's constraint.

The exploration output generated by the ML model explanation generation engine 102 in response to the query can thus include any or some combination of the following: (1) highlighted latent features indicating the contribution of each highlighted latent feature to a decision made by the VAE 106; (2) a prediction made by the VAE 106 in response to a query constraint; or (3) adjusted latent features of the latent space.

Based on the exploration output (feedback) produced by the ML model explanation generation engine 102, the user can select latent features of the latent space that are of interest to the user. For example, latent features may be more interesting due to their intrinsic ability to capture the most critical pattern or structures in input data that correspond to the underlying factors of variation. As a specific example, in image data, latent features may capture/encode semantic information while discarding less important details.

The ML model explanation generation engine 102 generates (at 208) a refined latent space based on the user selection. In some examples, the refined latent space may include a subset (less than all) of the latent features of the latent space output by the encoder 108 of the VAE 106. In a different example, the “refined” latent space can include all of the latent features of the latent space output by the encoder 108 of the VAE 106.

The ML model explanation generation engine 102 generates (at 210) an explanation for the VAE 106 by decoding selected points in the refined latent space.

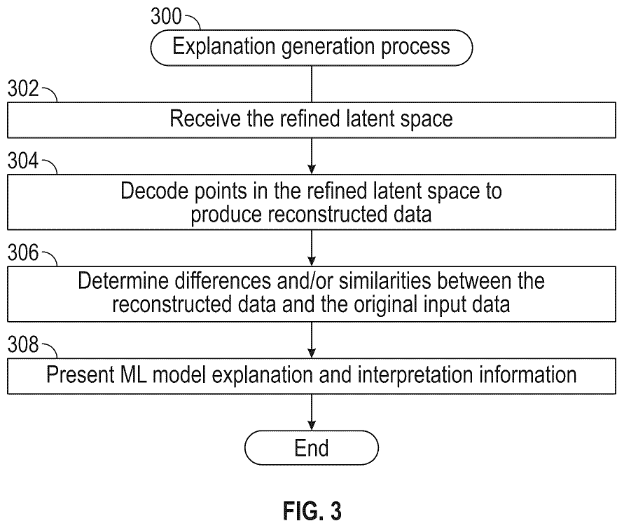

FIG. 3 is a flow diagram of an explanation generation process 300 that is an example of how the ML model explanation generation engine 102 generates (at 210) the explanation for the VAE 106. The explanation generation process 300 includes receiving (at 302) the refined latent space generated at 208.

The explanation generation process 300 includes decoding (at 304) points (latent features) in the refined latent space. The decoding is performed by the decoder 110. The decoder 110 reconstructs data X″ in the data domain based on the latent features in the refined latent space. Note that the refined latent space can include selected latent features as selected by the user based on feedback guided by queries. Thus, the reconstructed data X″ may differ from the reconstructed data X′ that is based on the full latent features of the latent space. The reconstructed data X″ may be referred to as “filtered” reconstructed data X″, since it is based on the refined latent space produced based on user exploration.

The explanation generation process 300 determines (at 306) differences and/or similarities between the reconstructed data X″ and the original input data X. The differences or similarities can be determined by comparing X″ to X, and identifying portions of X″ and X that differ from one another or that are similar to one another. The reconstructed data X″ is similar to the original input data X in overall structure and key features but may lose fine details, resulting in smoother or more generalized reconstructed data points. For example, reconstructed data from a VAE may have slight blurriness or variability due to the probabilistic nature of the latent space sampling. This comparison highlights which latent features are crucial and well-retained versus those that are simplified during the encoding and decoding process of the VAE 106. Highlighting the differences and similarities between X″ and X may enhance interpretability by providing a clear link between specific latent features and their impact on the generated output revealing which aspects of the data are of most important for the ML model's decision making.

The explanation generation process 300 presents (at 308) ML model explanation and interpretation information in a display device to be viewed by the user. The ML model explanation and interpretation information includes information specifying the importance of different latent features (i.e., the latent features highlighted based on the comparison of X″ and X) in influencing specific outcomes. Presenting the ML model explanation and interpretation information can help the user to understand how specific latent features influence the generated output by the VAE 106.

In some examples, the ML model explanation and interpretation information also includes information of counterfactual instances regarding how changes can lead to different outcomes of the VAE 106. A “counterfactual instance” refers to a modified collection of values of latent features of the VAE 106 that differ from another collection of values of the latent features. Counterfactual instances can lead to different outcomes by simulating alternative scenarios where specific latent features or conditions are changed to see how they impact predictions by the VAE 106. By altering values of certain latent features while keeping values of other latent features unchanged, counterfactual instances can help identify which latent features are primary contributors to a particular prediction of the VAE 106 and how modifications affect the VAE's decision. This allows for understanding causal relationships, evaluating model sensitivity, and potentially correcting biases by showing how small changes in inputs can lead to different predictions, thus highlighting the decision boundaries of the VAE 106.

A latent feature is a “primary contributor” if the latent feature contributed more to a decision of the VAE 106 (or more generally, any ML model) than another latent feature.

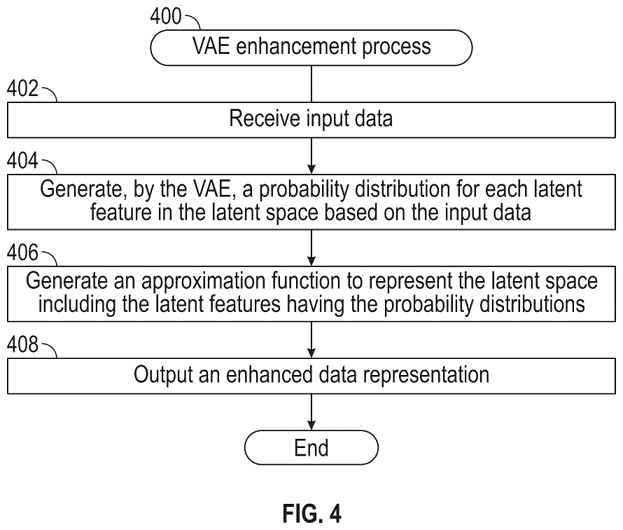

FIG. 4 is a flow diagram of a VAE enhancement process 400, according to some examples of the present disclosure. The VAE enhancement process 400 is an example of the enhancement performed at 202 in FIG. 2.

The VAE enhancement process 400 includes receiving (at 402) input data X. The encoder 108 of the VAE 106 generates (at 404) a probability distribution for each latent feature in the latent space based on input data X. For example, the input data X can be encoded to a mean μ and standard deviation σ defining a Gaussian distribution in the latent space. A latent vector z is sampled using reparameterization according to z=μ+σ·ϵ, where ϵ represents random noise introduced into the latent space typically from a standard normal distribution that helps in generalization. A loss function of the VAE 106 ensures that the latent space follows a standard normal distribution while maintaining good reconstruction quality of the reconstructed data X′. The encoded latent space becomes a compressed, structured, and continuous representation of the input data X, allowing both reconstruction and generation of similar data.

The VAE enhancement process 400 generates (at 406) an approximation function to represent the latent space including the latent features having the probability distribution produced by the encoder 108. As noted above, an example of the approximation function is the KAN. As discussed above, the KAN learns and approximates the complex multivariate latent function by breaking it down into simpler functions (univariate functions) to approximate the multivariate latent function to a target level of accuracy.

The VAE enhancement process 400 outputs (at 408) an enhanced data representation, which includes the encoded latent space and the approximation function.

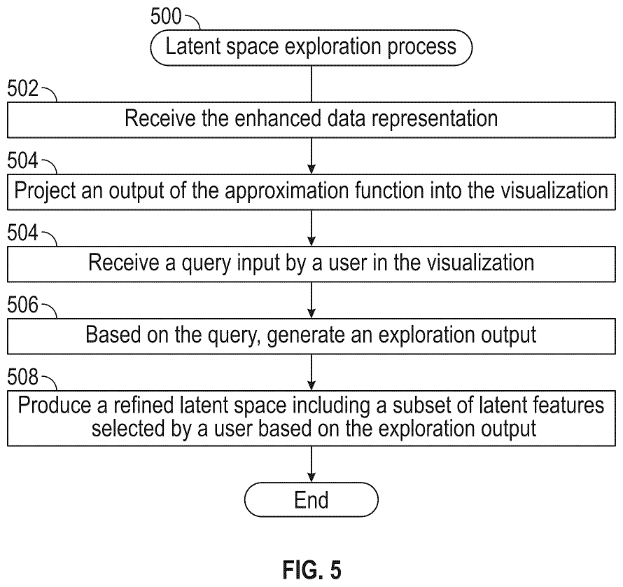

FIG. 5 is a flow diagram of a latent space exploration process 500, which is an example of how the ML model explanation generation engine 102 can present (at 204 in FIG. 2) the visualization of the latent features in the latent space to enable user exploration of the latent space.

The latent space exploration process 500 receives (at 502) the enhanced data representation from the VAE enhancement process 400 of FIG. 4. The latent space exploration process 500 projects (at 504) an output of the approximation function (e.g., the KAN) into the visualization. For example, an output of the KAN can be projected

The output of the KAN is projected using SHapley Additive explanations (SHAP), which is a game theoretic approach to explain the output of any ML model. The projection of the output of the KAN into the visualization using SHAP allows for a determination of how different latent features contribute to the predictions made by the VAE 106. SHAP is used for latent analysis to understand the latent features of the latent space.

The latent space exploration process 500 receives (at 506) a query input by a user in the visualization. The query can be based on a selection of N (N≥1) latent features presented in the visualization. Alternatively, the query can be input by the user into an input field of the visualization, where the user can specify a constraint.

Based on the query, the latent space exploration process 500 can generate (at 508) an exploration output. For example, in response to the selection of N latent features, the exploration output includes indicators highlighting the contribution of each of the selected N latent features to a decision made by the VAE 106.

As another example, in response to the query including a constraint, the reconstructed data X′ from the decoder 110 of the VAE 106 can be modified such that data points or latent features satisfy the constraint of the query. In some examples, a satisfiability solver can be used to process the query with the constraint.

The satisfiability solver is used to determine whether a given formula can be satisfied, i.e., whether there exists an assignment of values to the latent features that makes the formula true for optimizing model parameters or finding solutions in combinatorial spaces. The user defines certain constraints that are to be satisfied which can be represented using logical expressions or inequalities. The satisfiability solver returns an assignment of values to the latent features that meet the constraint.

Based on the exploration output, the user can choose a subset of latent features that are of interest to the user. The latent space exploration process 500 receives the selection of the subset of latent features, and produces (at 510) a refined latent space including the subset of latent features.

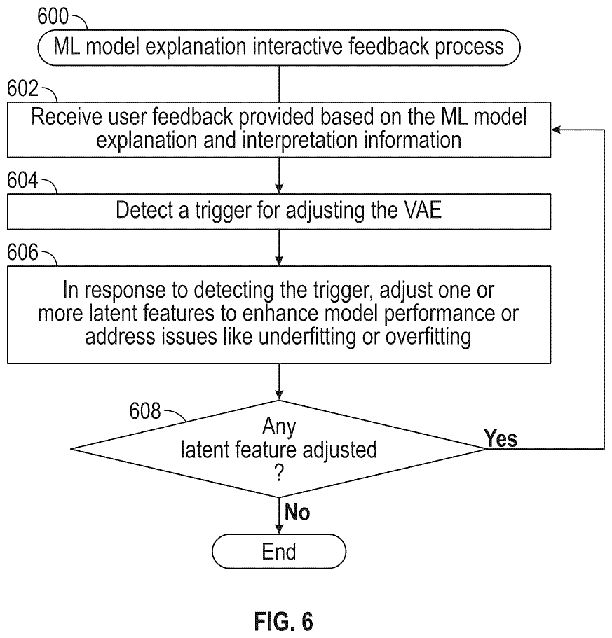

FIG. 6 is a flow diagram of an ML model explanation interactive feedback process 600 according to some examples of the present disclosure. The ML model explanation interactive feedback process 600 receives (at 602) user feedback provided based on the ML model explanation and interpretation information presented by the explanation generation process 300 of FIG. 3.

The feedback can include ratings provided by the user regarding the quality of the ML model explanation included in the ML model explanation and interpretation information. For example, the ML model explanation and interpretation information can highlight latent features {F1, F2, . . . } as being the primary contributors of a decision made by the VAE 106. However, the user may disagree, and may indicate that one or more of the highlighted latent features {F1, F2, . . . } should not be identified as a primary contributor of a decision made by the VAE 106.

Over time, one or more users may rate a specific latent feature (e.g., F2) as not being a primary contributor of a decision made by the VAE 106. The rating can be in the form of a selection that can be made by a user in a visualization presenting the ML model explanation and interpretation information. For example, the user can input a rating (e.g., 1 to 10 or high, medium, low) in an entry field of the visualization. Adjustments can be triggered in response to detecting consistently low ratings of certain latent features provided by one or more users. Consistently low-rated explanations may indicate that clearer and more interpretable reasoning in the VAE's outputs are to be provided.

Another trigger for adjustments includes detecting a high variance in predictions made by the VAE 106. High variance in predictions suggests overfitting or poor generalization. Regularization or additional data may be provided to improve consistency. High variance may be detected by comparing the distribution of the latent features and how they impact the output generated. Regularization or additional data may reduce the variance by simplifying the ML model and encouraging the use of relevant features while discouraging unnecessary complexity.

In response to detecting (at 604) a trigger (e.g., consistently low ratings or high variance) for adjusting the VAE 106, the ML model explanation interactive feedback process 600 can adjust (at 606) one or more latent features to enhance model performance or address issues like underfitting or overfitting. Adjustments can include latent feature importance weighting to make explanations more relevant and easier to understand. These changes to the latent features help improve predictions and make the explanations more user friendly and easier to understand.

The ML model explanation interactive feedback process 600 checks (at 608) if any latent feature was adjusted. If not, the ML model explanation interactive feedback process 600 ends. However, if any latent feature(s) was (were) adjusted, the ML model explanation interactive feedback process 600 returns to receiving (at 602) user feedback provided based on the adjusted latent feature(s).

In some examples, the ML model explanation generation engine 102 can be executed across multiple processing resources to improve the throughput of the ML model explanation generation engine 102. The processing resources can include processors, computers, or other types of processing resources. A processor can include a microprocessor, a core of a multi-core microprocessor, a microcontroller, a programmable integrated circuit, a programmable gate array, or another hardware processing circuit. Machine-readable instructions of the ML model explanation generation engine 102 are executable on a processor to perform various tasks. Machine-readable instructions executable on a processor can refer to the instructions executable on a single processor or the instructions executable on multiple processors.

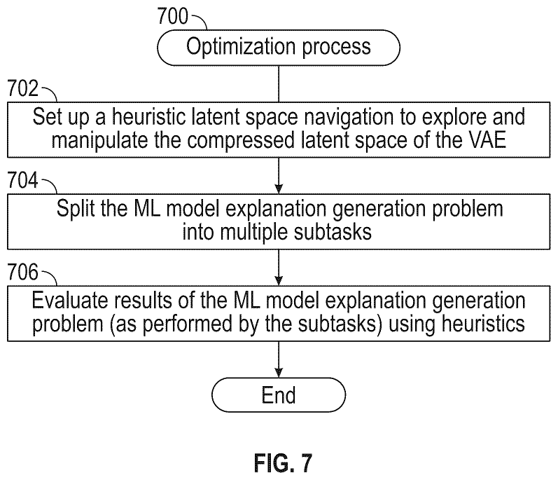

FIG. 7 is a flow diagram of an optimization process 700 to improve the throughput and efficiency of the ML model explanation generation engine 102. In some examples, the optimization process 700 includes setting up (at 702) a heuristic latent space navigation to explore and manipulate the compressed latent space of the VAE 106, by balancing computational cost with exploration depth. The heuristic latent space navigation prioritizes relevant regions of the latent space using strategies like sampling, clustering, and greedy search to ensure efficient exploration. The setup involves defining the latent space, choosing appropriate heuristics, and monitoring a cost-quality balance to optimize the exploration process.

Examples of heuristics can include the following. A first heuristic includes task segmentation to separate the latent space into interpretable latent features. Examples of such interpretable latent features include:
Feature 1: Sky brightness—that is, sunny, overcast.
Feature 2: Water texture—that is, calm, rippling.
Feature 3: Vegetation density—that is, either scant or rich foliage.

Symbolic expressions for such interpretable latent features can be produced using the KAN, e.g., producing the following interpretable correlation: bright sky increases contrast with water.

A second heuristic uses a constraint-based query. For example, a query can specify: “generate an image with bright sky, calm water, and maintain the current level of vegetation density. Such a constraint submitted with a query can produce a result in which the latent space's water texture feature and sky brightness feature are changed, while the vegetation density feature is unaltered.

If parallel processing is used, then the processing for the foregoing three features (water texture feature, sky brightness feature, and vegetation density feature) can be processed by different processing resources concurrently. The KAN algorithm can generate symbolic links that guarantee the constraints fit actual interpretations.

A third heuristic can employ the use of additional ML models that are in addition to the VAE 106. For example, to reduce complexity in evaluating the explanation, the reconstructed data X′ output from the VAE 106 can be partitioned into additional ML models, such as Random Forest or Logistic Regression models or other ML models.

The optimization process 700 splits (at 704) the ML model explanation generation problem into multiple subtasks, where the subtasks can be executed in parallel across multiple processing resources. The problem may be split according to various factors, such as complexity level or data independence and logical separations to enable tasks to run concurrently and reduce processing time.

The optimization process 700 evaluates (at 706) results of the ML model explanation generation problem (as performed by the subtasks) using heuristics, such as by applying practical rules to evaluate results quickly and reasonably rather than delving into exhaustive analysis methods. Heuristics come in handy in tackling issues under time constraints or optimal solution is not required. This approach strikes a balance between efficiency and efficacy by offering insights without having to employ complex computations.

The results produced by the subtasks in parallel can be combined. For example, if a query with a constraint is submitted, the combined result can satisfy the constraint in the query.

In examples where the reconstructed data X′ output from the VAE 106 is partitioned into additional ML models, the additional ML models can produce latent dimension feature significance ratings, which provides further interpretability context. In some examples, visual overlays can be presented to build a tiered explanation by showing which areas of an output were impacted by particular latent feature changes.

In some examples, machine-readable instructions can be used to carry out tasks according to some implementations of the present disclosure. The machine-readable instructions can be stored in a storage medium. A storage medium can include any or some combination of the following: a semiconductor memory device such as a dynamic or static random access memory (a DRAM or SRAM), an erasable and programmable read-only memory (EPROM), an electrically erasable and programmable read-only memory (EEPROM), or flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
obtaining, by a system comprising a hardware processor, an approximation function for a machine learning (ML) model, the approximation function providing an approximate representation of a latent representation of latent features in a latent space produced by the ML model;
presenting, by the system, a visualization of the latent features using the approximation function;
generating, by the system, a refined latent space based on user input in the visualization; and
generating, by the system, an explanation regarding which latent features of the refined latent space are primary contributors to a decision of the ML model.

2. The method of claim 1, wherein the ML model comprises an autoencoder, and the latent representation is produced by an encoder of the autoencoder.

3. The method of claim 2, wherein the autoencoder is a variational autoencoder (VAE), and the encoder of the VAE is to encode a probabilistic representation of the latent features in the latent space to produce the latent representation.

4. The method of claim 1, wherein the approximation function comprises a Kolmogorov Arnold Network (KAN).

5. The method of claim 1, wherein the presenting of the visualization of the latent features using the approximation function comprises projecting an output of the approximation function into a 2D or 2D space.

6. The method of claim 1, further comprising:
receiving, by the system, a user selection of a subset of the latent features; and
generating, by the system, an exploration output by adding indicators highlighting a contribution of each of the subset of the latent features to a decision made by the ML model,
wherein the user input that causes the generation of the refined latent space is responsive to the indicators.

7. The method of claim 1, further comprising:
receiving, by the system, a query comprising a constraint; and
generating, by the system, an exploration output in response to the query, wherein the exploration output comprises a modification of an output of the ML model to satisfy the constraint,
wherein the user input that causes the generation of the refined latent space is based on the modified output.

8. The method of claim 1, further comprising:
receiving, by the system, a query comprising a constraint; and
generating, by the system, an exploration output in response to the query, the exploration output comprising a manipulation of the latent space to satisfy the constraint,
wherein the user input that causes the generation of the refined latent space is based on the manipulated latent space.

9. The method of claim 1, wherein the refined latent space comprises a subset of the latent features in the latent space.

10. The method of claim 9, wherein the generating of the explanation comprises:
reconstructing, by the ML model, data using the subset of the latent features; and
determining, by the system, one or more of a difference or similarity between the reconstructed data and original input data to the ML model.

11. The method of claim 10, wherein the generating of the explanation comprises:
based on the determined one or more of the difference or similarity, determining, by the system, which latent feature of the subset of the latent features contributed more to a decision of the ML model than another latent feature of the subset of the latent features; and
identifying the latent feature that contributed more to the decision of the ML model in the explanation.

12. The method of claim 10, wherein the generating of the explanation comprises:
simulating, by the system, an operation of the ML model using modified values of the subset of latent features;
based on the simulating, determining, by the system, which latent feature of the subset of the latent features contributed more to a decision of the ML model than another latent feature of the subset of the latent features; and
identifying the latent feature that contributed more to the decision of the ML model in the explanation.

13. A system comprising:
a hardware processor; and
a non-transitory storage medium storing instructions executable on the hardware processor to:
produce an approximation function for a machine learning (ML) model, the approximation function providing an approximate representation of a latent representation of latent features in a latent space produced by the ML model;
present a visualization of the latent features using the approximation function;
generate a refined latent space based on user input in the visualization; and
generate an explanation regarding which latent features of the refined latent space are primary contributors to a decision of the ML model.

14. The system of claim 13, wherein the ML model is a variational autoencoder (VAE), and an encoder of the VAE is to encode a probabilistic representation of the latent features in the latent space to produce the latent representation.

15. The system of claim 13, wherein the latent space comprises a multivariate latent space including the latent features, and wherein the approximation function a Kolmogorov Arnold Network (KAN) that represents the multivariable latent space as a superposition of a number of univariate functions.

16. The system of claim 13, wherein the visualization comprises a two-dimensional (2D) or three-dimensional (3D) visualization, and the presenting of the visualization of the latent features using the approximation function comprises projecting an output of the approximation function into the 2D or 3D visualization.

17. The system of claim 13, wherein the instructions are executable on the hardware processor to:
receive a query that is based on the visualization; and
generate, in response to the query, an exploration output that satisfies the query,
wherein the user input that causes the generation of the refined latent space is responsive to the exploration output.

18. A non-transitory machine-readable storage medium comprising instructions that upon execution cause a system to:
produce an approximation function for a variational autoencoder (VAE), the approximation function providing an approximate representation of a latent representation of latent features in a latent space produced by an encoder of the VAE;
project an output of the approximation function into a visualization;
receive a query based on the visualization;
generate a refined latent space based on a result produced in response to the query; and
generate an explanation regarding which latent features of the refined latent space are primary contributors to a decision of the VAE.

19. The non-transitory machine-readable storage medium of claim 18, wherein the instructions upon execution cause the system to:
receive a user selection of a subset of the latent features presented in the visualization; and
generate an exploration output by adding indicators highlighting a contribution of each of the subset of the latent features to a decision made by the VAE.

20. The non-transitory machine-readable storage medium of claim 18, wherein the instructions upon execution cause the system to:
receive a query comprising a constraint; and
generate an exploration output in response to the query, wherein the exploration output comprises a modification of an output of the VAE to satisfy the constraint.
